(19) United States
(12) Patent Application Publication
(10) Pub. No.: US 2010/0199039 A1
(43) Pub. Date: Aug. 5, 2010

(54) Systems and Methods for Optimizing Host Reads and Cache Destages in a Raid System

(75) Inventors: Scott A. Bauman, Rochester, MN (US); Brian Bowles, Rochester, MN (US); Robert E. Galbraith, Rochester, MN (US); Adrian C. Gerhard, Rochester, MN (US); Tim B. Lund, Rochester, MN (US)

Correspondence Address: IBM CORPORATION, INTELLECTUAL PROPERTY LAW, DEPT 917, 3605 HIGHWAY 52 NORTH, ROCHESTER, MN, 55901-7829, US

(73) Assignee: International Business Machines Corporation, Armonk, NY (US)

(21) Appl. No.: 12/362,828

(22) Filed: Jan. 30, 2009

(51) Int. Cl. G06F 12/00

(52) U.S. Cl. 711/114; 711/E12.001

(57) ABSTRACT

In one aspect, a method of a storage adapter controlling a redundant array of independent disks (RAID) may be provided. The method may include examining performance curves of a storage adapter with a write cache, determining if an amount of data entering the write cache of the storage adapter has exceeded a threshold, and implementing a strategy based on the determining operation. The strategy may include one of coupling Read-XOR/Write operations and providing priority reordering of Read operations over the Read-XOR/Write operations in order to minimize host read response time if data entering the write cache is less than the threshold, and allowing all Read operations and Read-XOR/Write operations to be queued at the device using simple tags in order to achieve maximum throughput if data entering the write cache is greater than the threshold. Additional aspects are described.

### FIELD OF THE INVENTION

The present invention relates generally to enhancing the performance of a storage adapter for a Redundant Array of Independent Disks (RAID) and, more particularly, to systems and methods for optimizing host reads and cache destages in a RAID subsystem.

### BACKGROUND

Computing systems may include one or more host computers (“hosts”) for processing data and running application programs, storage for storing data, and a storage adapter for controlling the transfer of data between the hosts and the storage. The storage may include a Redundant Array of Independent Disks (RAID) storage device. Storage adapters, also referred to as control units or storage directors, may manage access to the RAID storage devices, which may be comprised of numerous Hard Disk Drives (HDDs) that maintain redundant copies of data (e.g., “mirror” the data or maintain parity data). A storage adapter may be described as a mechanism for managing access to a hard drive for read and write request operations, and a hard drive may be described as a storage device. Hosts may communicate Input/Output (I/O) requests to the storage device through the storage adapter.

A storage adapter and storage subsystem may contain a write cache to enhance performance. The write cache may be non-volatile (e.g., battery backed or Flash memory) and may be used to mask the “write penalty” introduced by a redundant array of independent disks (RAID) system such as RAID-5 and RAID-6 systems. A write cache may also improve performance by coalescing multiple host operations placed in the write cache into a single destage operation, which may then be processed by the RAID layer and disk devices.

Write command data sent by the host may be placed in cache memory to be destaged later to disk via the RAID layer. When using RAID such as RAID-5 and RAID-6, many of these cache destage operations may result in multiple pairs of Read-XOR/Write operations, where both operations of a pair are to the same logical block address (LBAs) on a disk. Each Read-XOR/Write pair may be the result of needing to either: 1) reading old data, XORing this old data with new data to produce a change mask, and then writing the new data OR 2) reading old parity, XORing this old parity with a change mask to produce new parity, and then writing the new parity. In both cases the Read-XOR operation to disk may need to be completed successfully to disk before the write operation may be able to be performed.

In “A Case for Redundant Arrays of Inexpensive Disks (RAID)”, Proc. of ACM SIGMOD International Conference on Management of Data, pp. 109-116, 1988, incorporated herein by reference, D. A. Patterson, G. Gibson and R. H. Katz describe five types of disk arrays classified as RAID levels 1 through 5. Of particular interest are disk arrays with an organization of RAID level 5, because the parity blocks in such a RAID type are distributed evenly across all disks, and therefore cause no bottleneck problems.

One shortcoming of the RAID environment may be that a disk write operation may be far more inefficient than on a single disk, because a data write on RAID may require as many as four disk access operations as compared with one disk access operation on a single disk. Whenever the disk controller in a RAID organization receives a request to write a data block, it may not only update (i.e., read and write) the data block, but it also may update (i.e., read and write) the corresponding parity block to maintain consistency. For instance, if data block D1 in FIG. 5 is to be written, the new value of P0 may be calculated as: new P0=(old D1 XOR new D1 XOR old P0).

Therefore, the following four disk access operations may be required: (1) read the old data block D1; (2) read the old parity block P0; (3) write the new data block D1; and (4) write the new parity block P0. The reads may need to be completed before the writes may be able to be started.

In “Performance of Disk Arrays in Transaction Processing Environments”, Proc. of International Conference on Distributed Computing Systems, pp. 302-309, 1992, J. Menon and D. Mattson teach that caching or buffering storage blocks at the disk controller may improve the performance of a RAID disk array subsystem. If there is a disk cache, the pre-reading from the disk array of a block to be replaced may be avoided if the block is in the cache. Furthermore, if the parity block for each parity group is also stored in the cache, then both reads from the disk array may be avoided if the parity block is in the cache.

A Read command sent by the host may not be satisfied by data in the write cache. Unlike a host Write command which may not need wait for a disk access (as long as there is a space in the write cache), a host Read command may wait for a disk to perform a Read operation. However, if the write cache is full, a host Write command may also need to wait for disk accesses (cache destages) to complete.

Performance of the storage subsystem may be greatly influenced by controlling the interaction of the disk Read operations (resulting from host Reads) and disk Read-XOR/Write operations (resulting from cache destages).

### SUMMARY OF THE INVENTION

According to an aspect of the invention, a method of a storage adapter controlling a redundant array of independent disks (RAID) may be provided. The method may include examining performance curves of a storage adapter with a write cache, determining if an amount of data entering the write cache of the storage adapter has exceeded a threshold, and implementing a strategy based on the determining operation. The strategy may include one of coupling Read-XOR/Write operations and providing priority reordering of Read operations over the Read-XOR/Write operations in order to minimize host read response time if data entering the write cache is less than the threshold, and allowing all Read operations and Read-XOR/Write operations to be queued at the device using simple tags in order to achieve maximum throughput if data entering the write cache is greater than the threshold.

According to another aspect of the invention, a storage adapter controlling a redundant array of independent disks (RAID) may be provided. The storage adapter may include a write cache, and storage adapter logic. The storage adapter logic may be configured to examine performance curves of the storage adapter, determine if an amount of data entering the write cache of the storage adapter has exceeded a threshold, and implement a strategy based on the determining operation. The strategy may include one of coupling Read-XOR/Write operations and providing priority reordering of Read operations over the Read-XOR/Write operations in order to minimize host read response time if data entering the write cache is less than the threshold, and allowing all Read operations and Read-XOR/Write operations to be queued at the device using simple tags in order to achieve maximum throughput if data entering the write cache is greater than the threshold.

According to another aspect of the invention, a system including a storage adapter controlling a redundant array of independent disks (RAID) may be provided. The system may include a cache memory coupled to the storage adapter and the RAID, the cache memory having a threshold, and storage adapter logic to examine performance curves of the storage adapter and the capacity of the cache memory. The storage adapter logic may determine if an amount of data entering the cache memory of the storage adapter has exceeded a threshold. The storage adapter logic may implement a strategy based on the determination of exceeding the threshold. The strategy may include one of coupling Read-XOR/Write operations and providing priority reordering of Read operations over the Read-XOR/Write operations in order to minimize host read response time if data entering the write cache is less than the threshold, and allowing all Read operations and Read-XOR/Write operations to be queued at the device using simple tags in order to achieve maximum throughput if data entering the write cache is greater than the threshold.

The foregoing and other aspects will become apparent from the following detailed description when considered in conjunction with the accompanying drawing figures.

### BRIEF DESCRIPTION OF THE FIGURES

FIG. 1 is a schematic diagram of the architecture of computer coupled to storage adapter and a disk array according to one aspect of the present invention;

FIG. 2 is a schematic plot of typical performance curves in a RAID system and an optimized performance curve in accordance with one aspect of the present invention;

FIG. 3 is a graphical illustration of cache threshold conditions in accordance with one aspect of the present invention;

FIG. 4 is a block diagram illustrating the architecture of a disk array subsystem;

FIG. 5 is a conventional RAID-5 data mapping showing the placement of data and parity blocks;

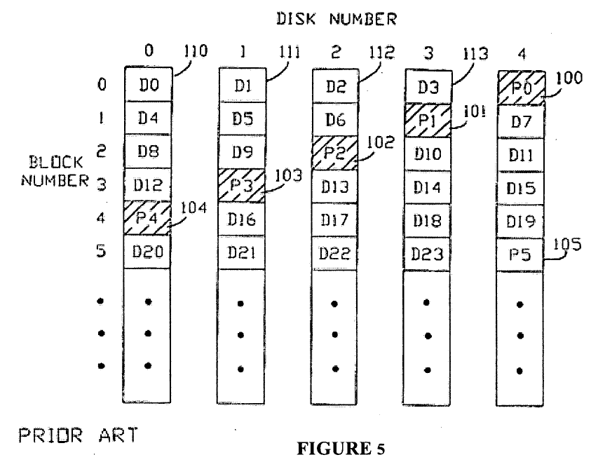

FIG. 6 is a flow diagram of a storage adapter dynamically measuring the performance of a cache memory and adjusting the interaction of the disk Read operations (resulting from host Reads) and disk Read-XOR/Write operations (resulting from cache destages); and

FIG. 7 is a flow chart of a storage adapter dynamically measuring the performance of a cache memory and adjusting the interaction of the disk Read operations (resulting from host Reads) and disk Read-XOR/Write operations (resulting from cache destages).

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

As used in this application, the terms “a”, “an” and “the” may refer to one or more than one of an item. The terms “and” and “or” may be used in the conjunctive or disjunctive sense and will generally be understood to be equivalent to “and/or”. For brevity and clarity, a particular quantity of an item may be described or shown while the actual quantity of the item may differ.

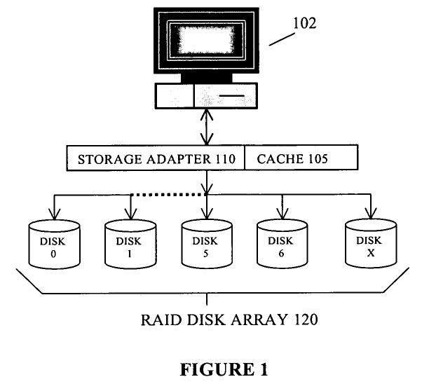

Systems and methods according to various aspects or embodiments of the present invention may provide an improved process for controlling the interaction of the disk Read operations (resulting from host Reads) and disk Read-XOR/Write operations (resulting from cache destages) in a redundant array of independent disk (RAID) system. An aspect of the present invention may be practiced on the disk array storage adapter shown in FIG. 1 for example. A host computer system 102 may read and write data via a storage adapter 110 to disk array 120. The storage adapter 110 may include a cache memory 105. The disk array may include an array of disks 0, 1, . . . X. The data mapping in the disk array 120 in one embodiment of the invention may be described as RAID level 5 (RAID-5). However, embodiments of the invention may be applicable to other RAID levels (e.g., RAID-0, 1, 6, etc.).

The storage adapter 110 may contain an algorithm for managing the write cache 105 for enhancing performance for the RAID system 120. The write cache 105 may be non-volatile (e.g., battery backed or FLASH memory) and may be used to mask the “write penalty” introduced by a RAID system 120. The “write penalty” may be the delay in disk access due to the time it takes to complete a host 102 write command to the RAID system 120. The write cache 105 may contain random access memory (RAM) that acts as a buffer between the host computer 102 and the RAID system 120. This may allow for a more efficient process for writing data to the RAID system 120. A write cache 105 may also improve performance by coalescing multiple host operations into a single destage operation, which may then be processed by the RAID system 120. These destage operations may include multiple pairs of Read-XOR/Write operations, such as reading old data, XORing (comparing) this old data with new data to produce a change mask, and then writing the new data. These destage operations may also include reading old parity data, XORing this old parity data with a change mask to produce new parity data, and then writing the new parity data. Data from host write commands may be placed in the write cache 105 giving the operation relatively quick host response. Host Read commands however, may not be satisfied by data in the write cache 105. Therefore, a host Read command may wait for a disk to perform a Read operation or other activities caused by a cache destage before the command is processed.

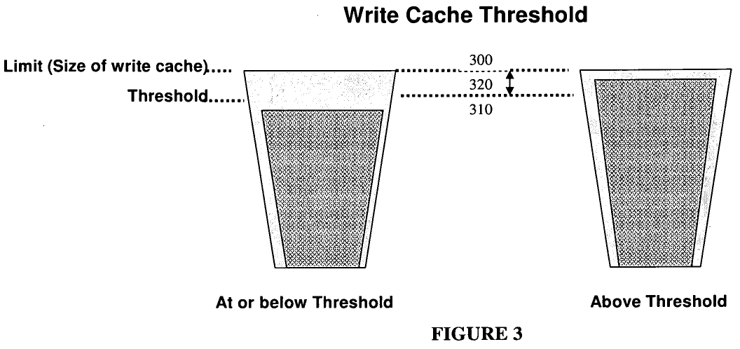

Prior art systems typically had to compromise in improving the disk Read operations (resulting from host reads) in order to minimize host response time versus improving disk Write or disk Read-XOR/Write operations (resulting from cache destages) in order to maximize overall throughput. An embodiment of the present invention seeks to provide the most desirable of both worlds. For example, as illustrated in FIG. 3, when data in the cache 105 is at or below a certain threshold level 310, the storage adapter may use tight coupling of Read-XOR/Write operations along with priority reordering of Read operations. This arrangement may force the RAID system 120 to complete a READ-XOR operation first and then complete the related write operations rather than allowing any intervening operations. Next, the system may include priority reordering of the Read operations. This arrangement may limit the number of disk seek operations between the READ-XOR operations and the Write operation. This may ensure cache destages take a minimum amount of time at disk, and thus minimize response time for a host. As data in the cache is at or below the threshold level 310, host write operations may also be performed with a minimum amount of latency. Similarly, when data in the cache 105 is above the threshold level 310, the write cache 105 may not be available to receive additional write operations. Therefore, an embodiment of the present invention may allow all Read operations and Read-XOR/Write operations to be queued at the device using simple tags in order to achieve maximum throughput if data entering the write cache is greater than the threshold. Embodiments of the present invention may allow for both maximized throughput and minimized response time.

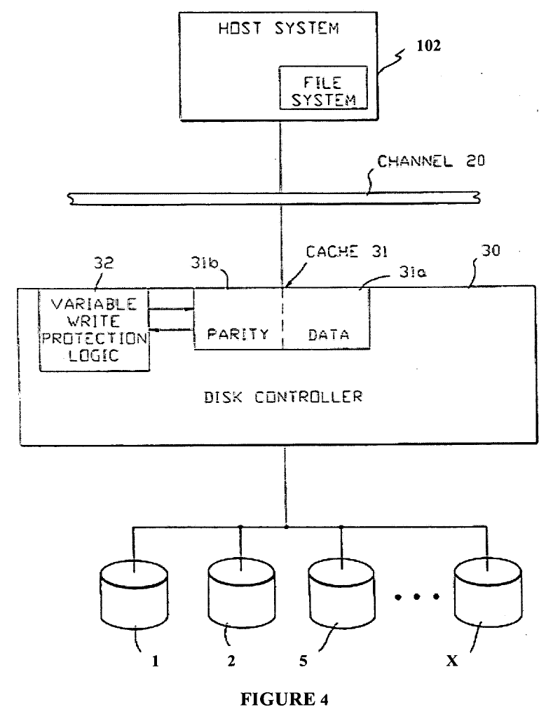

FIG. 4 shows a disk array subsystem architecture on which a RAID system can be implemented. The architecture may include a disk controller 30 connected to a host system 102, and may include a cache 31 that manages an array of inexpensive disks 1, 2, 5 . . . X. In a RAID organization with a total of N+1 disks, one parity block may be created for each N data blocks, and each of these N+1 blocks (N data blocks plus one parity block) may be stored on a different disk. In one embodiment, a parity block may be computed from the N data blocks by computing a bitwise “Exclusive Or” (XOR) of the N data blocks. The parity block along with the N data blocks from which that parity block was computed may be called a parity group. Any block in a parity group may be computed from the other blocks of that parity group.

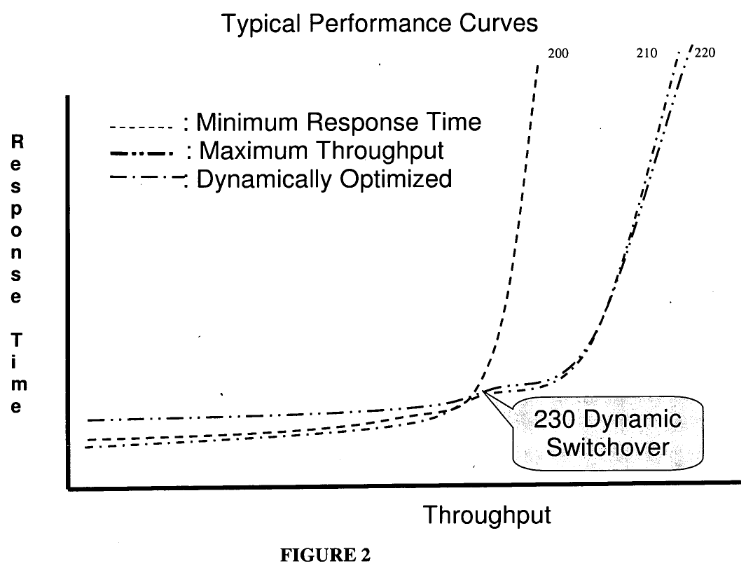

A key idea of an embodiment of the invention is to be able to detect when it may be acceptable to be somewhat less efficient in order to provide the host a more desirable response time and when it may be necessary to be the most efficient possible in order to provide the greatest throughput. In examining the typical performance curves shown in FIG. 2 for a storage adapter 30 with write cache 31 there may be a noticeable “knee” of the curve 230 where the cache 31 destages may no longer keep up with the rate at which data may be coming into the write cache 31. At this point, illustrated in FIGS. 2, 3 and 4, the cache 31 may fill up 300 and become full such that no new host Write commands may be quickly completed by placing the data into free cache space 320. When this occurs, the response time may increase dramatically and quickly producing the “knee” 230 of the curve. It may be at the “knee” 230 condition that it may be desirable to switch strategies.

At throughputs lower than the “knee,” 200 it may be desirable to use tight coupling of Read-XOR/Write operations along with priority reordering of Reads (resulting from host Reads) ahead of Read-XOR/Write operations (resulting from cache destages) in order to minimize host response time. With throughputs greater than the “knee,” 230 it may be desirable to allow all Reads (resulting from host reads) and Read-XOR/Write operations (resulting from cache destages) to be queued at the device using simple tags in order to achieve maximum throughput, similar to that shown in 220. Simple tags allow reordering of operations as needed to, for example, maximize a number of operations per second that may be performed.

Detection of the “knee” 230 may be implemented in several ways. A basic idea is to determine if write cache 31 has adequate free space (i.e., it is being kept at or below its established threshold) 320 or whether write cache 31 threshold or a per device cache threshold has been exceeded. Then, switching strategies when write cache 31 begins to exceed threshold may help avoid the cache 31 from encountering a cache full condition 300 and extend throughput (e.g., as shown by 210).

An embodiment of the present invention may solve this problem by providing a RAID storage adapter 110 that may dynamically change the interaction of the disk Read operations (resulting from host computer Reads) and disk Read-XOR/write operations (resulting from cache destages) in order to maximize overall throughput and minimize host response time. This may apply to normal parity updates for RAID levels such as RAID-5 and RAID-6. Still another embodiment of the present invention may dynamically change the interaction of the disk Read operations (resulting from host Reads) and disk Write operations (resulting from cache destages) in order to maximize overall throughput and minimize host response time. This may apply to RAID levels such as RAID-0 and RAID-1 and to stripe writes with RAID-5 and RAID-6.

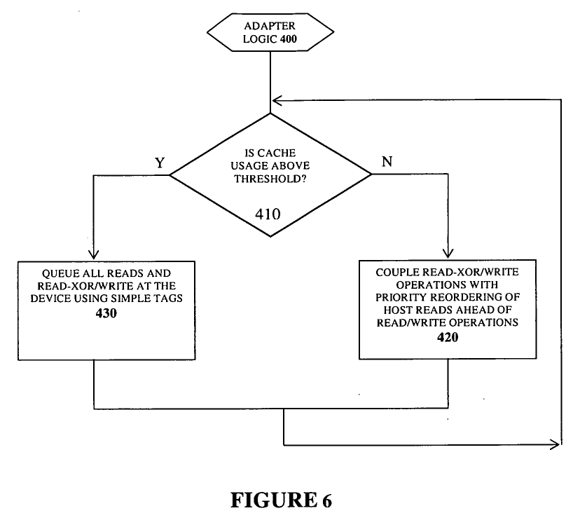

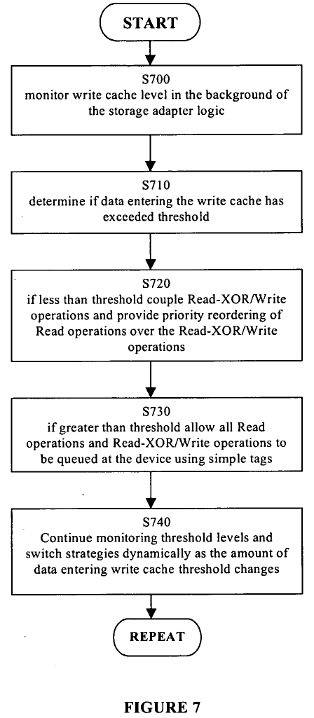

The dynamic operation of the storage adapter 110 is illustrated in the flow diagrams of FIGS. 6 and 7, wherein the cache level monitor logic 400 operates in the background of the storage adapter logic at operation S700. Under normal conditions when the cache memory 31 levels are at or below the cache memory threshold, the storage adapter 110 may operate to minimize host response time. For example, the cache level monitor logic 400 may determine if the cache memory 31 is at or below a threshold value 410 in operation 710. If the cache memory 31 is at or below threshold, the storage adapter 110 tightly couples Read-XOR/Write operations along with priority reordering of host Read operations 420 at operation 720 so that they are ahead of Read-XOR/Write operations resulting from cache destages. However, if the cache memory 31 has exceeded the memory threshold, the storage adapter 110 may allow all host Read operations and the Read-XOR/Write operations 430 resulting from cache destages to be queued at the device using simple tags in order to achieve maximum throughput at operation 730. The storage adapter 110 then repeats the process by continuing to monitor 410 cache memory 31 levels at operation 740.

The tight coupling of the Read-XOR/Write pair operations 420 may prevent other operations from occurring before the Write of a Read-XOR/Write pair is completed. This may be done by treating the Read-XOR/Write as though they were Untagged (let other tagged operations finish to the disk, perform the Read-XOR/Write, and then dispatch other operations which may have since been queued in the adapter). Alternatively using Ordered tags with the Read-XOR/Write may be used to tightly couple Read-XOR/Write pairs.

As already noted, under conditions where write cache 31 has adequate free space (at or below threshold), it may not be desirable for host response time to make a Read operation wait behind a Read-XOR/Write operation. It may be preferable under these conditions to force the Read-XOR/Write operation to be prioritized behind the Read operations 420 in order to minimize the response time for host Read commands.

Allowing the storage adapter 110 to dynamically change the interaction of the disk Read operations and the disk Read-XOR/Write operations may allow the system to both maximize overall throughput and minimize host response time.

The foregoing description discloses only exemplary embodiments of the invention. Modifications of the above-disclosed embodiments of the present invention of which fall within the scope of the invention will be readily apparent to those of ordinary skill in the art. For instance, although in some embodiments, RAID 5 may be discussed, the system may be applicable to RAID levels 3, 4, 6, 10, 50, 60, etc.

Accordingly, while the present invention has been disclosed in connection with exemplary embodiments thereof, it should be understood that other embodiments may fall within the spirit and scope of the invention as defined by the following claims.

The invention claimed is:

1. A method of a storage adapter controlling a redundant array of independent disks (RAID), comprising:
examining performance curves of a storage adapter with a write cache;
determining if an amount of data entering the write cache of the storage adapter has exceeded a threshold; and
implementing a strategy based on the determining operation, wherein the strategy comprises one of;
coupling Read-XOR/Write operations and providing priority reordering of Read operations over the Read-XOR/Write operations in order to minimize host read response time if data entering the write cache is less than the threshold, and
allowing all Read operations and Read-XOR/Write operations to be queued at the device using simple tags in order to achieve maximum throughput if data entering the write cache is greater than the threshold.

2. The method according to claim 1 wherein the coupling of the Read-XOR/Write operations comprises pairing the Read-XOR/Write operations such that no other operation can occur between the paired Read-XOR/Write operations.

3. The method according to claim 1, wherein the allowing of all Read operations and Read-XOR/Write operations to be queued at the device using simple tags comprises sending all operations to the device and allowing the device to prioritize the operations to maximize throughput.

4. The method according to claim 1, wherein the determining if the amount of data entering the write cache of the storage adapter has exceeded the threshold comprises determining if the amount of data entering the write cache of the storage adapter is at or below the threshold or above the threshold and headed to a write cache full condition.

5. The method according to claim 4, wherein the determining if the amount of data entering the write cache of the storage adapter has exceeded the threshold comprises determining if the amount of data has exceeded an overall cache threshold or a per device cache threshold.

6. The method according to claim 4, wherein the strategy is switched dynamically when the write cache begins to exceed the threshold such that throughput is extended and a write cache full condition is avoided.

7. A storage adapter controlling a redundant array of independent disks (RAID), comprising:
a write cache; and
storage adapter logic configured to:
examine performance curves of the storage adapter;
determine if an amount of data entering the write cache of the storage adapter has exceeded a threshold; and
implement a strategy based on the determining operation, wherein the strategy comprises one of;
coupling Read-XOR/Write operations and providing priority reordering of Read operations over the Read-XOR/Write operations in order to minimize host read response time if data entering the write cache is less than the threshold, and
allowing all Read operations and Read-XOR/Write operations to be queued at the device using simple tags in order to achieve maximum throughput if data entering the write cache is greater than the threshold.

8. The storage adapter according to claim 7 wherein, the coupling of the Read-XOR/Write operations comprises pairing the Read-XOR/Write operations such that no other operation can occur between the paired Read-XOR/Write operations.

9. The storage adapter according to claim 7, wherein the allowing all Read operations and Read-XOR/Write operations to be queued at the device using simple tags comprises sending all operations to the device and allowing the device to prioritize the operations to maximize throughput.

10. The storage adapter according to claim 7, wherein, the storage adaptor logic configured to determine if the amount of data entering the write cache of the storage adapter has exceeded the threshold comprises storage adapter logic configured to determine if the amount of data entering the write cache of the storage adapter is at or below the threshold or above the threshold and headed to a write cache full condition.

11. The storage adapter according to claim 10, wherein the storage adapter logic configured to determine if the amount of data entering the write cache of the storage adapter has exceeded the threshold comprises storage adapter logic to determine if the amount of data has exceeded an overall cache threshold or a per device cache threshold.

12. The storage adapter according to claim 10, wherein the strategy is switched dynamically when the write cache begins to exceed the threshold such that throughput is extended and a write cache full condition is avoided.

13. A system including a storage adapter controlling a redundant array of independent disks (RAID), comprising:
a cache memory coupled to the storage adapter and the RAID, the cache memory having a threshold; and
storage adapter logic to examine performance curves of the storage adapter and the capacity of the cache memory, wherein the storage adapter logic determines if an amount of data entering the cache memory of the storage adapter has exceeded a threshold, and wherein the storage adapter logic implements a strategy based on the determination of the storage adapter logic, the strategy comprising one of:
coupling Read-XOR/Write operations and providing priority reordering of Read operations over the Read-XOR/Write operations in order to minimize host read response time if data entering the write cache is less than the threshold, and
allowing all Read operations and Read-XOR/Write operations to be queued at the device using simple tags in order to achieve maximum throughput if data entering the write cache is greater than the threshold.

14. The system according to claim 13 wherein, the coupling of the Read-XOR/Write operations comprises pairing the Read-XOR/Write operations such that no other operation can occur between the paired Read-XOR/Write operations.

15. The system according to claim 13, wherein the allowing of all Read operations and Read-XOR/Write operations to be queued at the device using simple tags comprises sending all operations to the device and allowing the device to prioritize the operations to maximize throughput.

16. The system according to claim 13, wherein the determination of the storage adapter logic comprises determining if the amount of data entering the cache memory of the storage adapter is at or below the threshold or whether the amount of data entering the cache memory of the storage adapter has exceeded the threshold and is headed to a cache memory full condition.

17. The system according to claim 16, wherein the determination of the storage adapter logic comprises determining if the amount of data has exceeded an overall cache threshold or a per device cache threshold.

18. The system according to claim 16, wherein the storage adapter logic switches strategies dynamically when the cache memory begins to exceed the threshold such that throughput is extended and a cache memory full condition is avoided.

19. The system according to claim 13, wherein the coupling of Read-XOR/Write operations and providing priority reordering of the Read operations over the Read-XOR/Write operations applies to parity updates for RAID levels RAID-5 and 6.

20. The system according to claim 13, wherein the allowing all Read operations and Read-XOR/Write operations to be queued at the device using simple tags applies to stripe writes and parity updates for RAID levels RAID-0 and 1 by comprising allowing all Read operations and Write operations to be queued at the device.
